(19) United States
(12) Patent Application Publication
(10) Pub. No.: US 2012/0319364 A1
(43) Pub. Date: Dec. 20, 2012

(54) CHUCK ASSEMBLY FOR LIGHT ALLOY WHEELS

(75) Inventors: Masaru Oki, Yao (JP); Muneki Hiraoka, Yao (JP)

(73) Assignee: Teikoku Chuck Co., Ltd., Osaka (JP)

(21) Appl. No.: 13/581,327

(22) PCT Filed: Feb. 10, 2011
(86) PCT No.: PCT/JP2011/052890

§ 371 Date: Aug. 27, 2012

(30) Foreign Application Priority Data
May 20, 2010 (JP) 2010-116102

(51) Int. Cl. B23B 31/30

(52) U.S. Cl. 279/2.06

(57) ABSTRACT

A chuck assembly for a light alloy wheel is used with a lathe for machining a workpiece, and includes: a chuck body fixed to be coaxial with a lathe spindle; a flexible power chuck including radially extending first second cylinder chambers located on first and second sectional surfaces, respectively, of the chuck body perpendicular to a chuck body axis along outer peripheries of the first and second sectional surfaces, respectively, and pistons received in the first and second cylinder chambers, the pistons being moveable by fluid pressure to grip the inner surface of the rim member in a compensating manner; and a retracting chuck to grip and center the hub mounting portion, and then pull the disk portion to press against a reference surface of the chuck body, whereby the lathe can machine an entire radially outer surface of the rim member.

### TECHNICAL FIELD

This invention relates to a chuck assembly for light alloy wheels used when turning light-alloy wheels such as aluminum wheels or magnesium wheels.

### BACKGROUND ART

Typical turning of a light alloy wheel such as an aluminum wheel or a magnesium wheel comprises a plurality of steps carried out using a finger chuck assembly having three to six finger jaws.

By way of example, FIGS. 6(a) and 6(b) show how a light alloy wheel (hereinafter referred to as the “workpiece W”) is machined using an ordinary finger chuck assembly. The workpiece W includes a disk portion D, and an annular rim member A provided on the outer edge of the disk portion D and having flanges B at both widthwise ends of the rim member A.

The disk portion D includes a hub mounting portion (hub hole) C at its center, and bolt holes arranged with a predetermined pitch around the hub mounting portion C. The rim member A may comprise two separate pieces, one located nearer to the disk portion D than the other.

The turning operation shown in FIGS. 6(a) and 6(b) comprises two steps. In the first step, see FIG. 6(a), one of the flanges B is brought into abutment with a clamp seat 5 provided at the front portion of a chuck body and clamped between the finger jaws 6 and the clamp seat 5, with a designed end surface 1 of the disk portion D facing inwardly.

In this state, the inner surface 2 of the of the disk portion D around the hub mounting portion C, the radially inner surface 4 of the rim member A, etc. are turned. Portions of the radially outer surface 3 of the rim member A with which the finger jaws 6 do not interfere are further turned.

Besides the finger clamp mechanism comprising the finger jaws 6 and the clamp seat 5, the finger chuck assembly ordinarily further includes a centering mechanism.

One typical centering mechanism includes a spring adapted to elastically push out a plate provided at the front of the chuck assembly, thereby radially outwardly pushing and centering the rim member A with a tapered portion provided at the outer edge of the plate. Another centering mechanism includes a spring adapted to elastically push out a tapered cone, thereby radially outwardly pushing and centering the hub mounting portion C with an radially outer tapered surface of the tapered cone.

In the second step, portions that were not turned in the first step are turned. In the second step, as shown in FIG. 6(b), the workpiece is turned over so that the designed end surface 1 of the disk portion D now faces outwardly, and the other flange B is clamped between the finger jaws 6 and the clamp seat 5. Centering is carried out using one of the above-mentioned centering mechanisms.

In this state, the designed end surface 1 of the disk portion C of the workpiece W and the remaining portions of the radially outer surface 3 of the rim member A are turned (see e.g. Patent documents 1-3).

### PRIOR ART DOCUMENTS

### Patent Documents

Patent document 1: JP Patent Publication 9-66410A
Patent document 2: JP Patent Publication 9-94709A
Patent document 3: JP Patent Publication 7-68405A

### SUMMARY OF THE INVENTION

### Object of the Invention

When any of such conventional chuck assemblies for light alloy wheels is used, in the first step, the hub mounting portion C, and portions of the radially inner surface (4) and radially outer surface (3) of the rim member A are machined. In the second step, the remainder of the radially outer surface (3) of the rim member A and the disk portion D are machined.

Since a larger area has to be machined in the first step than in the second step, the first step may need a longer time than the second step. The first step is thereof often divided into two sub-steps. That is, three steps of approximately equal duration are needed to machine a workpiece.

This means that a plurality of steps are necessary to machine the radially outer surface (3) of the rim member A, and thus a long time is necessary to machine the workpiece.

Since the finger clamp mechanism is used, which clamp a rim flange B of the workpiece W between the finger jaws 6 and the clamp seat 5, the finger jaws 6 grip the outer periphery of the rim flange B of the workpiece W.

In this arrangement, during high-speed rotation, centrifugal force pulls the finger jaws 6 radially outwardly, thus reducing their gripping force. This limits the maximum rotational speed.

The rim flange B, which is gripped by the finger jaws 6, is not flat but has a complicated shape including inclined surfaces and protrusions and recesses.

Thus, with a rim flange B of the workpiece W clamped with the finger jaws 6, when pressure is applied to the center axis area of the workpiece W (near the hub mounting portion C) and/or the radially outer surface of the rim member A, these portions may move because the rim flanges B are not flat and thus the area of the workpiece W that is contact with the finger jaws 6 changes.

This results in misalignment of the workpiece W relative to the axis of the chuck body. Such misalignment may occur even during machining of the rim member A. If this happens, the balance of the resulting wheel will be large.

An object of the present invention is to shorten the time for turning a light alloy wheel, and reduce misalignment of the workpiece during machining.

### Means to Achieve the Object

In order to achieve this object, the present invention provides a chuck assembly for a light alloy wheel for use with a lathe for machining a workpiece in a second step, the workpiece comprising a disk member having a central hub mounting portion, and an annular rim member provided along an outer circumference of the disk member and having rim flanges on both sides of the rim member in the widthwise direction of the rim member, wherein the second step is carried out after a first step in which at least a radially inner surface of the rim member and an inner surface of the disk portion are turned, and wherein the chuck assembly is configured to clamp the inner surface of the disk portion and the hub mounting portion as references when machining the workpiece with the lathe in the second step, wherein the chuck assembly comprises: a chuck body configured to be fixed in position so as to be coaxial with a center axis of a spindle of the lathe; a flexible power chuck comprising at least 12 angularly equally spaced, radially extending first cylinder chambers which are equal in diameter to each other and located on a first sectional surface of the chuck body perpendicular to a center axis of the chuck body along the outer periphery of the first sectional surface, at least 12 angularly equally spaced, radially extending second cylinder chambers which are equal in diameter to each other and located on a second sectional surface of the chuck body perpendicular to the center axis of the chuck body along the outer periphery of the second sectional surface, pistons received in the respective first and second cylinder chambers, and rods that are moved together with the respective pistons, wherein pressure fluid is configured to be supplied into the respective cylinder chambers, thereby moving the respective pistons and thus the rods until a radially inner surface of the rim member is gripped in a compensating manner by distal ends of the respective rods along the circumferences of the first and second sectional surfaces; and a retracting chuck configured to grip the hub mounting portion so as to center the hub mounting portion, and then pull the disk portion until the inner surface of the disk portion is pressed against a reference surface of the chuck body, whereby the lathe can machine an entire radially outer surface of the rim member.

In the first step of turning, at least the radially inner surface of the rim member and the inner surface of the disk portion are turned while gripping the workpiece with e.g. a conventional finger chuck assembly. In the second step, which is carried out after the first step, in order to turn e.g. the radially outer surface of the rim member (and/or the designed end surface of the disk portion), the chuck assembly according to the present invention is used.

The chuck assembly according to this invention grips only the hub mounting portion for centering, and the radially inner surface of the rim member, in the second step. Thus, it is possible to machine the entire radially outer surface of the rim member because the radially outer surface of the rim member is not gripped by the chuck assembly. This eliminates the necessity to turn any portion of the radially outer surface of the rim member in the first step, shortening the duration of the first step.

Since the radially inner surface of the rim member is gripped for compensation by the large number of pistons and rods arranged along the circumferences of axially spaced apart sectional surfaces of the chuck body extending perpendicular to the axis of the chuck body, the workpiece is prevented from going out of true during machining. That is, the flexible power chuck never influences the centering accuracy by the retracting chuck, so that a well-balanced wheel is formed.

The retracting chuck itself may be a conventional one.

The arrangement of the present invention shortens the duration of the first step, even to substantially the same as the duration of the second step, though this may depend on the type of the workpiece and how the workpiece is turned.

In conventional arrangements, a noticeable seam frequently developed between areas of the workpiece machined in the first and second steps, respectively, (due to misalignment). With the arrangement of the present invention, a seamless finish is possible if the entire radially outer surface of the rim member is machined with two turning tools (for machining in the opposite directions of the axis of the spindle, respectively). This improves the outer appearance of the wheel formed and thus increases its commercial value.

Since the chuck assembly for light alloy wheels according to the present invention grips the radially inner surface of the workpiece, centrifugal force serves to increase, rather than reduce, the force with which the pistons and rods are pressed against the radially inner surface of the rim member. The chucking ability of this chuck assembly is not influenced by the rotational speed.

Conventional finger chuck assemblies include markedly radially outwardly protruding finger jaws, so that they have a large outer diameter. The chuck assembly for light alloy wheels has no such protruding portions, and thus is small in outer diameter. This means that its moment of inertia is small compared to the conventional finger chuck assemblies if their weights are the same.

Finger jaws produce a large swishing noise when they are rotated at high speed due to air resistance (which could scare operators). The air resistance increases the load on the motor. The chuck assembly according to the present invention has no protruding portions on its outer circumference portion that could encounter air resistance. This reduces swishing noise and minimizes the load on the motor. The chuck assembly of the invention can be said to be environmentally friendly.

Preferably, the distal ends of the rods define flat surfaces perpendicular to axes of the corresponding cylinder chambers, the flat surfaces being configured to be brought into abutment with the radially inner surface of the rim member.

The flat surface of each rod abuts the radially inner surface of the rim member at two points of the edge of the flat surface because the portion of the radially inner surface of the rim member that abuts the rods is substantially cylindrical. Pressing force thus concentrates on the two points of each flat surface. This allows firm grip of the workpiece and also prevents rotation of the workpiece about the axis of any rod during turning of the workpiece.

The rods may each comprise a rod body and a grip member detachably mounted on the rod body, with the flat surfaces formed on the respective grip members.

With this arrangement, since the grip members are detachable, the grip members can be changed to ones with a different shape and/or size according to the shape and size of the workpiece. This improves versatility of the chuck assembly.

Preferably, the flat surface of each of the grip members has a protruding portion protruding radially outwardly from a portion of the corresponding rod that is received in the cylinder chamber, whereby the protruding portion of the flat surface is configured to grip a portion of the radially inner surface of the rim member that is smaller in inclination angle than a portion of the radially inner surface axially aligned with the rod.

On a plane containing the axis of the chuck body, the portion of the radially inner surface of the rim member gripped by each grip member is preferably as small as possible in inclination angle relative to the axis of the chuck body. In this regard, even if the inclination angle of the radially inner surface of the rim member relative to the axis of the chuck body is relatively large as a whole, it is possible to grip a portion of the radially inner surface of the rim member where the inclination angle is relatively small by protruding the flat surface in the above manner.

### Advantages of the Invention

With the arrangement of the present invention, it is possible to shorten the time period necessary to turn a light alloy wheel and to prevent misalignment of the workpiece during machining.

### BRIEF DESCRIPTION OF THE DRAWINGS

FIGS. 1(a) and 1(b) are a sectional side view and a front view of an embodiment, respectively.

FIG. 2 is a partial enlarged view of FIG. 1(a).

FIG. 3 is a partial enlarged view of FIG. 1(b).

FIG. 4 is a perspective view of the embodiment.

FIG. 5 is a partial enlarged sectional view of another embodiment.

FIGS. 6(a) and 6(b) are sectional side views of a conventional chuck assembly.

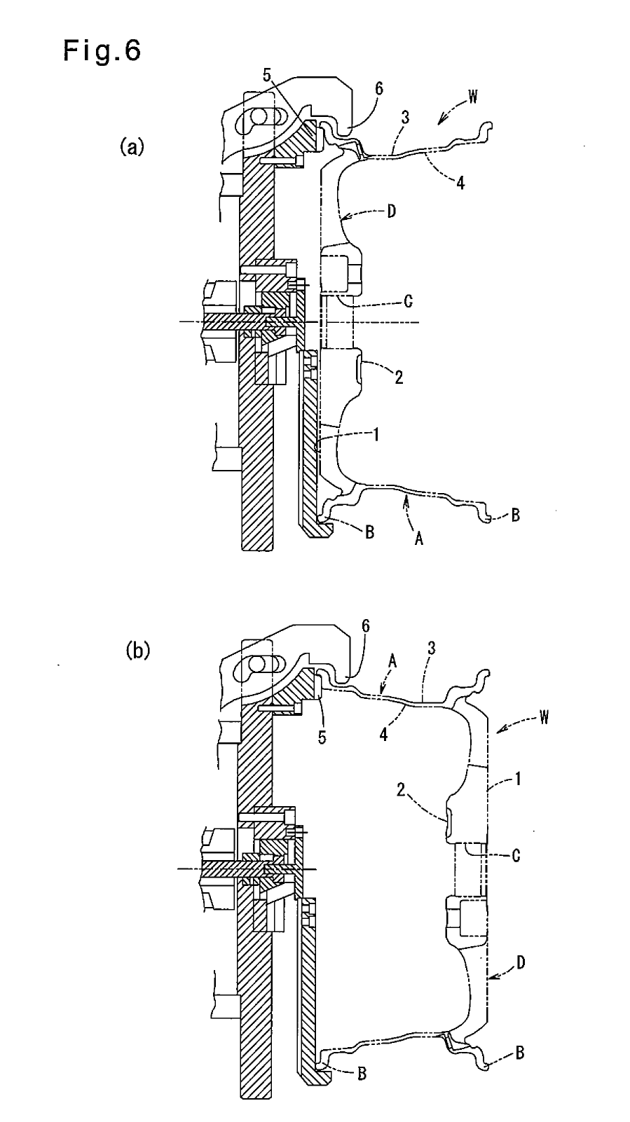

### BEST MODE FOR EMBODYING THE INVENTION

The embodiment of the present invention is described with reference to the drawings. The chuck assembly M for light alloy wheels of this embodiment is mounted on a lathe, and configured to grip a workpiece W in the form of a one-piece light alloy wheel comprising a disk member D having a hub mounting portion C at its center and bolt holes provided around the hub mounting portion C, and an annular rim member A provided around the disk member D and having rim flanges B on both widthwise sides thereof.

This chuck assembly M is used in a second step of turning of the workpiece W. In particular, in a first step, which is carried out before the second step, at least the radially inner surface 4 of the rim member A and the inner surface 2 of the disk portion D, of the workpiece W are turned. The workpiece W is then clamped by the chuck assembly M with the inner surface 2 of the disk portion D and the radially inner surface of the hub mounting portion C as references, and the second step is carried out, in which the entire radially outer surface 3 of the rim member A and a designed end surface 1 of the disk portion D are turned.

The chuck assembly M comprises a chuck body 10 coaxially fixed to the spindle of the lathe, a flexible power chuck provided at the outer periphery of the chuck body 10 and gripping the inner surface 4 of the rim member A in the workpiece W, and a small retracting chuck at the front of the chuck body 10 capable of retracting the workpiece W and including a stopper 9 for axially positioning the workpiece W relative to the chuck body 10.

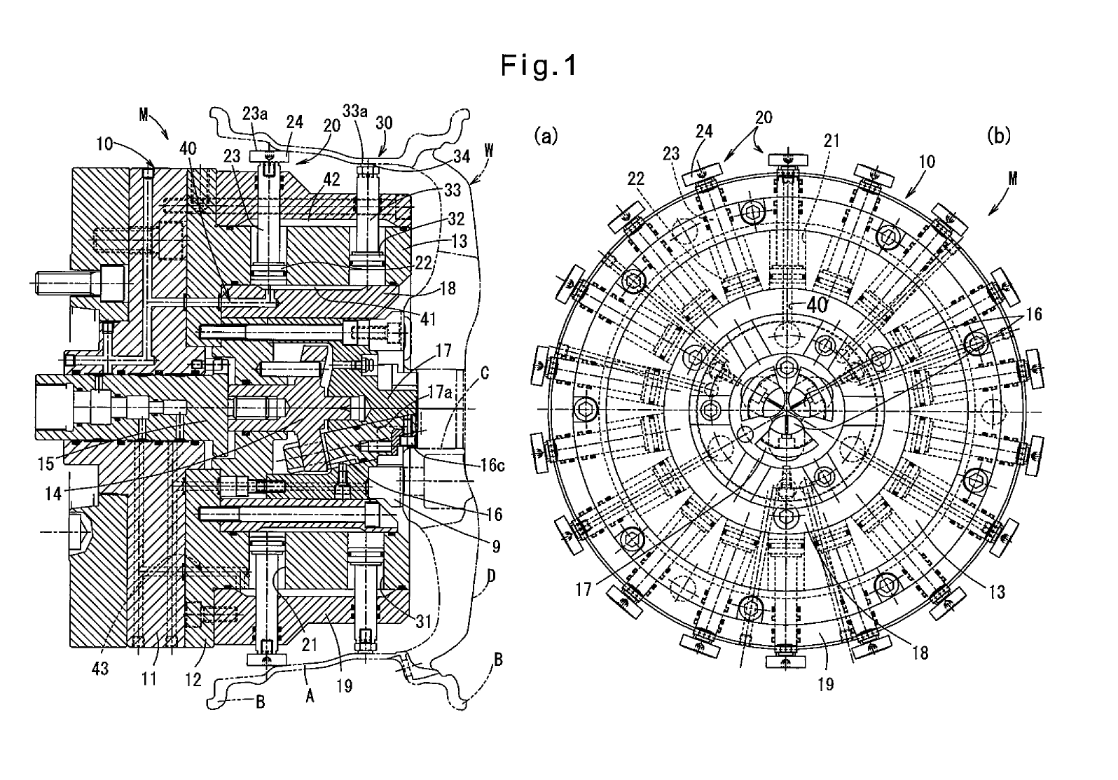

As shown e.g. in FIG. 1(a), the chuck body 10 comprises a back plate 11, an adapter plate 12, a main body portion 13, a center member 17, an annular member 18, and an outer peripheral member 19, which are fixed together by e.g. bolts.

The flexible power chuck includes a first grip means 20 and a second grip means 30 which are spaced from each other in the direction of the center axis of the chuck body 10.

The first grip means 20 includes 18 angularly equally spaced, radially extending first cylinder chambers 21 which are equal in diameter to each other and located on a first sectional surface of the chuck body 10 perpendicular to the center axis of the chuck body 10 along the outer periphery of the first sectional surface.

Similarly, the second grip means 30 includes 18 angularly equally spaced, radially extending first cylinder chambers 31 which are equal in diameter to each other and located on a second sectional surface of the chuck body 10 perpendicular to the center axis of the chuck body 10 along the outer periphery of the second sectional surface.

The number of the first cylinder chamber 21 and the number of the second cylinders 31 may be greater or smaller than 18 according to the type of the workpiece W and the specs of the lathe. But for the below-described gripping for compensation, these numbers have to be both at least 12.

A first piston 22 is received in each of the first cylinder chambers 21 of the first grip means 20 so as to be movable in both axial directions of the first cylinder chamber 21. Each first piston 22 integrally carries a first rod 23 protruding radially outwardly from the chuck body 10. A first grip portion (grip member) 24 is detachably and threadedly mounted on the distal end of each first rod 23. These members constitute cylinders.

The cylinders of the first grip means 20 are of the double-acting type, and are connected to a common oil passage 40 provided radially inwardly of the first pistons 22 and a common oil passage 43 provided radially outwardly of the first pistons 22.

The radially inner oil passage 40 communicates with all of the first cylinder chambers 21 through an oil passage 41 defined between the annular member 18, which is provided around the center axis of the chuck body 10, and the main body portion 13, which is provided around the annular member 18. The oil passage 41 is defined by the radially inner surface of the main body portion 13 and a recess formed on the radially outer surface of the annular member 18 to extend its entire circumference. Thus, an identical fluid pressure is applied to all of the first cylinder chambers 21 from a common fluid pressure supply source.

The radially outer oil passage 43 communicates with all of the first cylinder chambers 21 through an oil passage 42 defined between the outer peripheral member 19, which is provided around the chuck body 10, and the main body portion 13, which is provided radially inwardly of the member 19. The oil passage 42 is defined by the radially outer surface of the main body portion 13 and a recess formed on the radially inner surface of the outer peripheral member 19 to extend its entire circumference. Thus, an identical fluid pressure is applied to all of the first cylinder chambers 21 from a common fluid pressure supply source.

A second piston 32 is received in each of the second cylinder chambers 31 of the second grip means 30 so as to be movable in both axial directions of the second cylinder chamber 31. Each second piston 32 integrally carries a second rod 33 protruding radially outwardly from the chuck body 10. A second grip portion (grip member) 34 is detachably and threadedly mounted on the distal end of each second rod 33. These members constitute cylinders.

The cylinders of the second grip means 30 are also of the double-acting type, and are connected to the radially inner and outer oil passages 40 and 43 while sandwiching the second piston 32 of the second cylinder chamber 31.

But instead, the cylinders of the second grip means 30 may be connected to radially inner and outer oil passages that are different from the oil passages 40 and 43 and connected to a fluid pressure supply source that is different from the fluid pressure supply source to which the oil passages 40 and 43 are connected.

Pressure fluid supplied into the respective cylinder chambers moves the first and second pistons 22 and 33, and thus moves the first and second rods 23 and 33 together with the respective first and second pistons 22 and 33, thereby gripping for compensation the radially inner surface 4 of the rim member A on the above-mentioned first and second sectional surfaces, respectively, which are spaced apart from each other in the direction of the axis of the chuck body 10, along the circumferences of respective first and second sectional surfaces.

According to the specific shape of the rim member A of the workpiece W (light alloy wheel), the length of the second rods 33 of the second grip means 30 and the length of the portions of the second rods 33 radially outwardly protruding from the chuck body are short compared to the length of the first rods 23 of the first grip means 20 and the radially outward protruding length of the first rods 23 such that the first and second pistons 22 and 32 are moved the same distance when the workpiece W is gripped by the first and second grip means.

The length of the first rods 23 of the first grip means 20 and the length of the second rods 33 of the second grip means 30, which are different from each other, may be changed suitably. The first cylinders 21 and the second cylinders 31 have the same sectional area in the embodiment. But the former may have a different sectional area from the latter.

In this embodiment, the first rods 23 of the first grip means 20 and the second rods 33 of the second grip means 30 have, at their distal ends, flat surfaces 23a and 33a extending perpendicular to the axes of the respective first cylinder chambers 21 and second cylinder chambers 31 and configured to abut the radially inner surface 4 of the rim member A.

More specifically, the flat surfaces 23a and 33a are formed on the detachable first and second grip portions 24 and 34 of the respective first and second rods. Thus, it is possible to exchange the first and second grip portions 24 and 34 for new ones formed with flat surfaces 23a and 33a having a different area.

In this embodiment, the first and second grip portions 24 and 34 have threaded shaft portions 24a and 34a, respectively. The threaded shaft portions 24a and 34a are threaded into threaded holes 23b and 33b formed in the distal ends of the first and second rods 23 and 33, respectively, so as to extend in the axial directions of the respective rods, thereby fixing the grip portions in position.

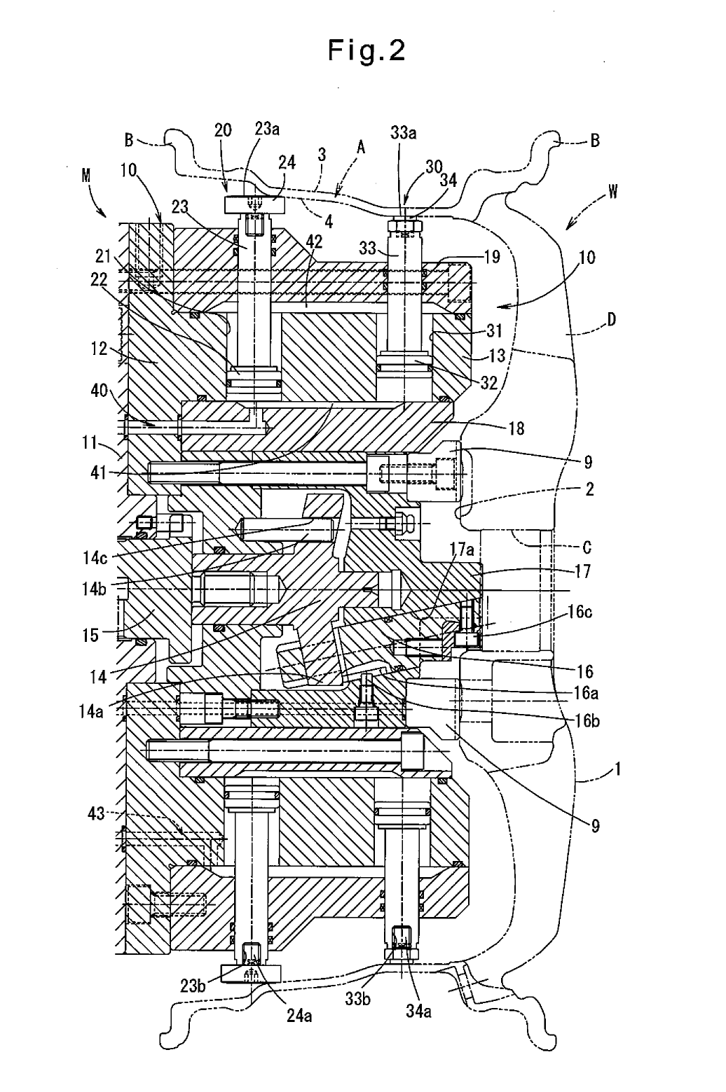

In this embodiment, as shown in FIG. 2, the flat surface 23a of each first grip portion 24 protrudes radially outwardly from the radially outer surface of the portion of the corresponding first rod 23 that is received in the first cylinder chamber 21. The flat surface 23a also radially outwardly protrudes from the extension of the inner wall of the corresponding first cylinder 21.

Each flat surface 23a thus supports, at this protruding portion, a portion of the radially inner surface 4 of the rim member A that is slightly offset from its portion axially aligned with the rod 23 toward the disk portion C and is smaller in inclination angle than the portion of the radially inner surface 4 axially aligned with the rod 23.

Now description is made of the retracting with a centering function. The retracting chuck includes three grip portions 16c provided at the front center of the chuck body 10 around the center axis of the chuck body 10.

The grip portions 16c grip the radially inner surface of the hub mounting portion C, thereby centering the portion C, and then pull the workpiece until the inner surface 2 of the disk portion D is pressed against the stopper 9, which serves as the reference surface of the chuck body 10.

An actuator 14 is mounted in a space defined by the back plate 11, adaptor plate 12 and a center member 17 so as to be movable along the axis of the chuck body 10 by the movement of a drawbar 15.

The center member 17 has three inclined holes 17a angularly spaced apart from each other around the axis of the chuck body 10. The inclined holes 17a are inclined relative to the axis of the chuck body 10.

The numbers of the grip portions 16c and the inclined holes 17a are not limited to three but have to be the same. A shaft-shaped master jaw 16 is snugly fitted in each inclined hole 17a. The master jaws 16 are connected to connecting portions 14a of the actuator 14 so that as the actuator 14 moves in the axial direction of the chuck body 10, the master jaws 16 moves in the respective inclined holes 17a in the axial directions of the respective holes 17a. A pin 16b is engaged in a groove 16a formed on the outer surface of each master jaw 16, thereby preventing rotation of the master jaw 16 about its axis.

The master jaws 16 carry the respective grip portions 16c at their front ends, so that when the master jaws 16 move in the respective inclined holes 17a, the grip portions 16c move radially of the chuck body 10, thereby pulling and centering the workpiece in the above-mentioned manner.

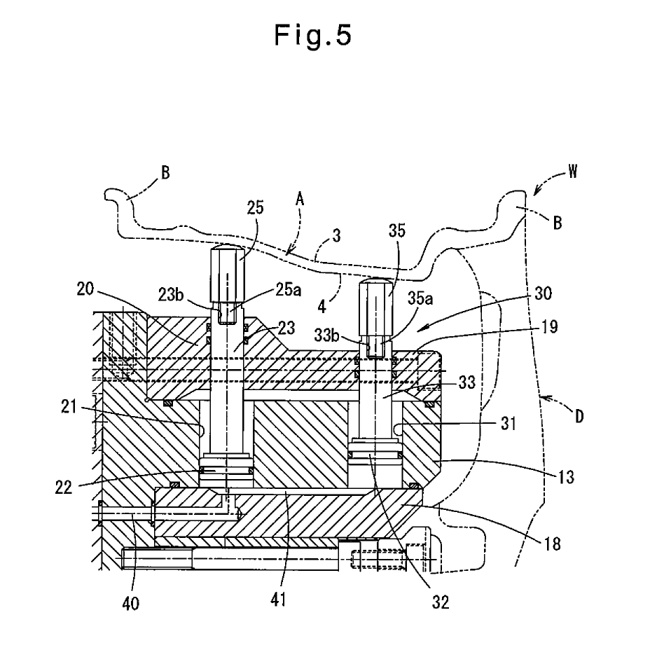

Now description is made of how the workpiece is turned using the chuck assembly of this embodiment, for light alloy wheels. After the workpiece W has been subjected to the (conventional) first step (see FIG. 5(a)), the workpiece W is turned over and placed on the chuck body 10 as shown in FIGS. 1(a) and 2.

With the radially inner surface of the hub mounting portion C centered by the retracting chuck, the retracting chuck is retracted until the inner surface 2 of the disk portion D is pressed against and fixed to the front surface of the stopper 9.

In this state, pressure fluid (hydraulic oil in the embodiment) is supplied through the radially inner oil passage 40 (first port) to the respective cylinders of the first and second grip means 20 and 30, thereby protruding the respective first and second rods 23 and 33 by the same distance to fix the radially inner surface 4 of the rim member A of the workpiece W. At this time, the oil passage 43 (second port) is open to the atmosphere. Even if the radially inner surface 4 of the rim member A is eccentric, the radially inner surface 4 is never moved or deformed by the first and second rods 23 and 33 of the flexible power chuck in the same manner as with compensating chucks.

In this state, the entire radially outer surface 3 of the rim member A is turned. It is also possible to turn the designed end surface 1 of the disk portion D.

By supplying pressure fluid (hydraulic oil in this embodiment) into the respective cylinders of the first and second grip means 20 and 30 through the oil passage 43 (second port), the first and second rods 23 and 33 are retracted by the same distance. At this time, the oil passage 40 (first port) is open to the atmosphere.

Generally speaking, since small retracting chucks are small in gripping torque, a workpiece W for a light alloy wheel tends to slip or jump out of the chuck due to cutting resistance. When a rim flange B is gripped by conventional finger jaws 6, the workpiece may chatter because the turned portion of the rim member A is axially spaced from its clamp portion.

The chuck assembly according to the present invention is free of this problem, because the flexible power chuck provides a large gripping torque by gripping the radially inner surface 4 of the rim member A with the large number of cylinders.

The flexible power chuck has no centering function, while the rim member A of a typical light alloy wheel has an inclination angle (relative to the axis of the chuck body). Thus, force acts on the inclined rim member which tends to float the workpiece W (i.e. move the workpiece in the forward direction).

The retracting chuck of the chuck assembly of this invention pulls the workpiece W, thereby preventing such floating of the workpiece.

The chuck assembly of this embodiment is used together with a lathe for machining the designed end surface 1 of the disk portion D of the light alloy wheel, and the entire radially outer surface 3 of the rim member A in the second step. In the embodiment, the cylinder stroke of the flexible power chuck is set at 30 mm.

This means that the diameter of the circle connecting the distal ends of the rods increases by 60 mm. Thus, this chuck assembly can grip any of 14-, 15- and 16-inch light alloy wheels. The piston stroke of the flexible power chuck is preferably 26 millimeters (1 inch) or larger.

The first and second rods 23 and 33 of the flexible power chuck may each have a flat distal end surface 23a, 33a that is perpendicular to the axis of the corresponding rod 23, 33.

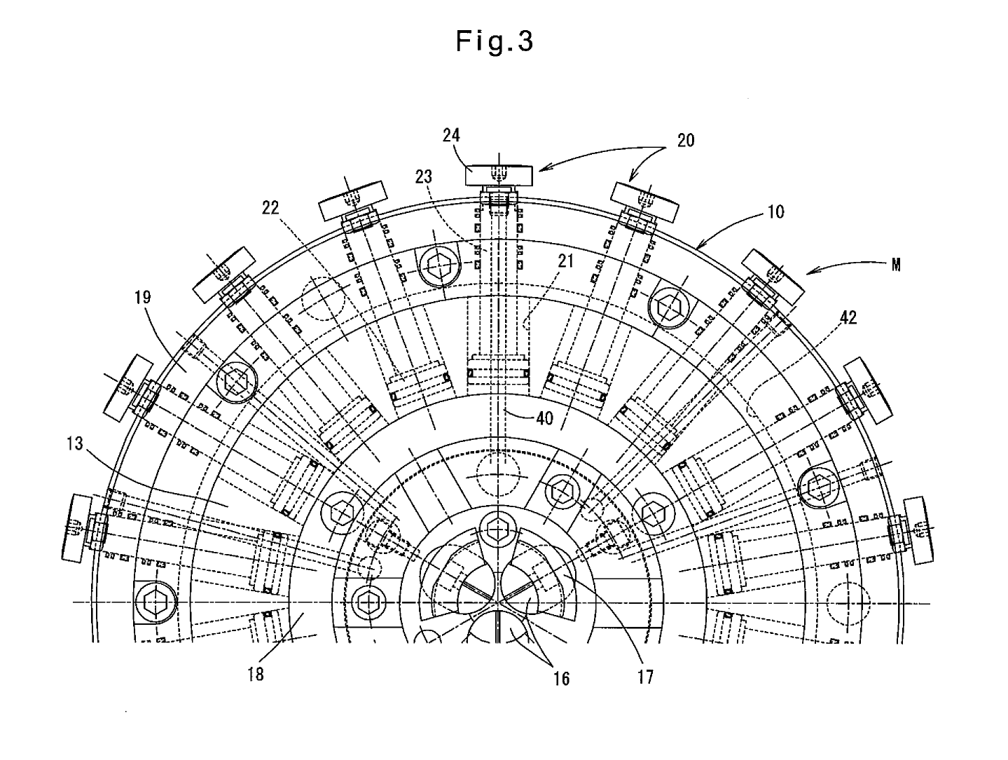

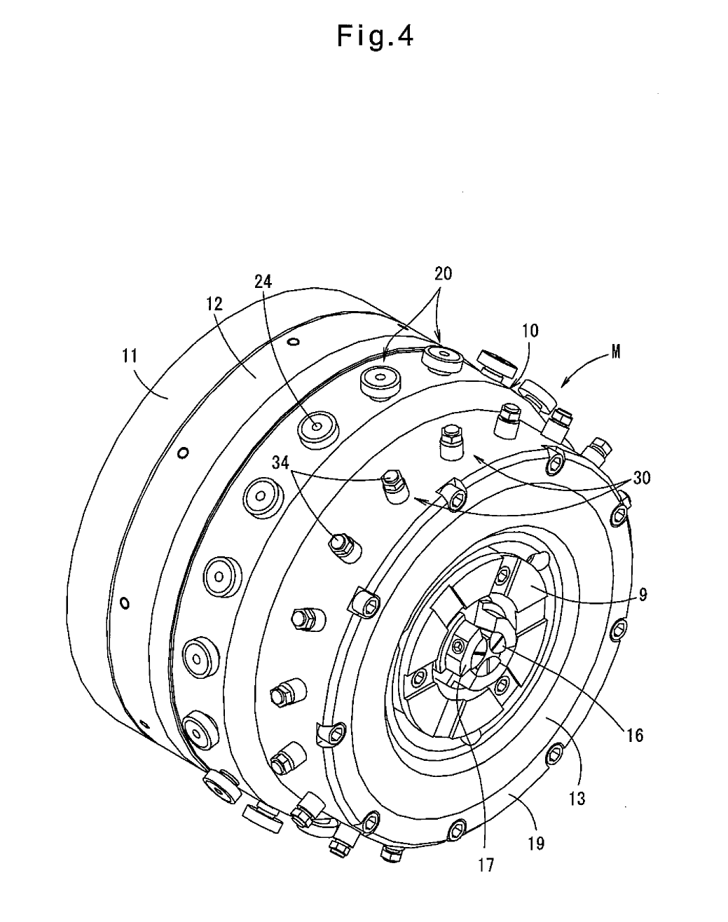

Alternatively, only the flat surfaces 23a (on the first rods 23) or only the flat surfaces 33a (on the second rods 33) may be formed. In the embodiment of FIGS. 1 to 4, both the flat surfaces 23a and 33a are formed (on the first rods 23 and the second rods 33, respectively). The grip portions formed with the flat surfaces 23a are made of cemented carbide. The grip portions formed with the flat surfaces 33a are made of urethane.

By forming the flat surfaces 23a and 33a at the distal ends of the respective rods 23 and 33, each flat surface 23a, 33a abuts the radially inner surface 4 of the rim member A at two points of the edge of the flat surface. Pressing force thus concentrates on the two points of each flat surface. This allows firm grip of the workpiece and also prevents rotation of the workpiece about the axis of any rod 23, 33 during turning of the workpiece. If necessary, the edges of the flat surfaces 23a and 33a may be chamfered.

In a modified arrangement, identically shaped extension rods 25 having a length permissible from the safety and design viewpoints are detachably mounted on the distal ends of the respective first rods 23, and identically shaped extension rods 35 having a length permissible from the safety and design viewpoints are detachably mounted on the distal ends of the respective second rods 33. The chuck assembly of this arrangement can grip workpieces W having different inner diameters. For example, by using extension rods 25 and 35 each one inch long, and replacing the rods 23 and 33 with ones which are one inch longer, it is possible to grip a workpiece W (light alloy wheel) two inches larger in size.

The extension rods 25 and 35 may be threadedly and detachably mounted.

For example, in the arrangement of FIG. 5, the first rod 23 and the second rod 33 are each formed with a threaded hole 23b, 33b in its distal end surface so as to extend in the axial direction of the corresponding rod 23, 33 (i.e. in a radial direction of the chuck body 10), and the extension rods 25 and 35 each have a threaded shaft 25a, 35a configured to be detachably threaded into the corresponding threaded hole 23b, 33b.

Instead of the extension rods 25 and 35, the first grip portions (grip members) 24 and the second grip portions (grip members) 34 may be threaded into the respective threaded holes 23b and 33b.

By using the extension rods 25 and 35, the diameters of some or all of the rods 23 and 33 may be increased according to the inclination of the rim member A, or their distal ends may be formed into a spherical shape to prevent damage to the workpiece W. A plastic material may be embedded in each extension rod 25, 35 at its portion adapted to abut the workpiece W.

The retracting chuck is not limited to the one shown in the embodiment but may be of any other known type.

### DESCRIPTION OF THE NUMERALS

1. Designed end surface
2. Inner surface
3. Radially outer surface
4. Radially inner surface
5. Clamp seat
6. Finger jaw
9. Stopper
10. Chuck body
11. Back plate
12. Adaptor plate
13. Main body portion
14. Actuator
14a. Connecting portion
15. Drawbar
16. Master jaw
16a. Groove
16b. Pin
16c. Grip portion
17. Center member
18. Annular member
19. Outer peripheral member
20. First grip means
21. First cylinder chamber
22. First piston
23. First rod
24. First grip portion
25, 35. extension rod
30. Second grip means
31. Second cylinder chamber
32. Second piston
33. Second rod
34. Second grip portion
40, 41, 42, 43. Oil passage
A. Rim member
B. Rim flange
C. Hub mounting portion
D. Disk portion
M. Chuck assembly for light alloy wheels

1-4. (canceled)

5. A chuck assembly for a light alloy wheel for use with a lathe for machining a workpiece (W) in a second step, said workpiece comprising a disk member (D) having a central hub mounting portion (C), and an annular rim member (A) provided along an outer circumference of the disk member (D) and having rim flanges (B) on both sides of the rim in the widthwise direction of the rim member, wherein the second step is carried out after a first step in which at least a radially inner surface (4) of the rim member (A) and an inner surface (2) of the disk portion (D) are turned, and wherein the chuck assembly is configured to clamp the inner surface (2) of the disk portion (D) and the hub mounting portion (C) as references when machining the workpiece with the lathe in the second step,
characterized in that the chuck assembly comprises:
a chuck body (10) configured to be fixed in position so as to be coaxial with a center axis of a spindle of the lathe;
a flexible power chuck comprising at least 12 angularly equally spaced, radially extending first cylinder chambers (21) which are equal in diameter to each other and located on a first sectional surface of the chuck body (10) perpendicular to a center axis of the chuck body (10) along the outer periphery of the first sectional surface, at least 12 angularly equally spaced, radially extending second cylinder chambers (31) which are equal in diameter to each other and located on a second sectional surface of the chuck body (10) perpendicular to the center axis of the chuck body (10) along the outer periphery of the second sectional surface, pistons (22 and 32) received in the respective first and second cylinder chambers (21 and 31), rods (23 and 33) that are moved together with the respective pistons (22 and 32), and a single common fluid pressure supply source for supplying pressure fluid into the respective cylinder chambers (21 and 31), thereby moving the respective pistons (22 and 32) and thus the rods (23 and 33) radially outwardly of the chuck body (10) by the same distance until a radially inner surface (4) of the rim member (A) is gripped in a compensating manner by distal ends of the respective rods (23 and 33) along the circumferences of the first and second sectional surfaces; and
a retracting chuck configured to grip the hub mounting portion (C) so as to center the hub mounting portion, and then pull the disk portion (D) until the inner surface (2) of the disk portion (D) is pressed against a reference surface of the chuck body (10), whereby the lathe can machine an entire radially outer surface (3) of the rim member (A).

6. The chuck assembly of claim 5, wherein the distal ends of the rods (23 and 33) define flat surfaces (23a and 33a) perpendicular to axes of the corresponding cylinder chambers (21 and 31), said flat surfaces (23a and 33a) being configured to be brought into abutment with the radially inner surface (4) of the rim member (A).

7. The chuck assembly of claim 6, wherein the rods (23 and 33) each comprise a rod body and a grip member (24, 34) detachably mounted on the rod body, and wherein said flat surfaces (23a and 33a) are formed on the respective grip members (24 and 34).

8. The chuck assembly of claim 7, wherein the flat surface (23a, 33a) of each of the grip members (24 and 34) has a protruding portion protruding radially outwardly from a portion of the corresponding rod (23, 33) that is received in the cylinder chamber (21, 31), whereby the protruding portion of the flat surface (23a, 33a) is configured to grip a portion of the radially inner surface (4) of the rim member (A) that is smaller in inclination angle than a portion of the radially inner surface (4) axially aligned with the rod (23, 33).
